(19) United States
(12) Patent Application Publication
(10) Pub. No.: US 2006/0229409 A1
(43) Pub. Date: Oct. 12, 2006

(54) Method for preparing polyurethane dispersions

(76) Inventor: Pavel E. Ilmenev, Ridgefield, CT (US)

Correspondence Address: CYTEC INDUSTRIES INC., 1937 WEST MAIN STREET, P.O. BOX 60, STAMFORD, CT, 06904-0060, US

(21) Appl. No.: 11/101,594

(22) Filed: Apr. 8, 2005

(51) Int. Cl. C08G 18/08

(52) U.S. Cl. 524/589

(57) ABSTRACT

A method for making polyurethane dispersions by (i) reacting m-TMXDI with a active hydrogen containing compounds to provide a prepolymer; dispersing the prepolymer in an aqueous medium to provide a prepolymer dispersion; and (iii) extending the prepolymer to provide a polyurethane dispersion. Using the isocyanate m-TMXDI permits the step of prepolymer formation and the step of extending the prepolymer to be conducted at higher temperatures than is possible with other isocyanates. The method is particularly useful for viscous active hydrogen containing compounds and/or active hydrogen containing compounds that provide viscous prepolymers.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### SEQUENCE LISTING

Not applicable.

### FIELD OF THE INVENTION

The present invention relates to methods of making a polyurethane dispersions.

### BACKGROUND OF THE INVENTION

Polyurethane is a term used to describe polymers prepared by reacting polyisocyanates with a polyactive hydrogen compound such as a polyfunctional alcohol, amine, and/or mercaptan. Polyurethanes, depending on their composition, can have a variety of properties, i.e., strength, tensile strength, flexibility, and adhesion to various substances. Accordingly, polyurethanes are used in a variety of applications including use as an elastomer, adhesive, coating, or impregnating agent. Polyurethanes can be supplied as a “polyurethane dispersion,” i.e., a dispersion of the polyurethane in an aqueous medium, especially when the polyurethane is used as an adhesive or a coating.

The aqueous polyurethane dispersion is generally prepared by a process that involves (i) preparing a —NCO terminated prepolymer, typically obtained by reacting a diisocyanate and a polyol; (ii) dispersing the prepolymer in an aqueous solvent and (iii) chain extending the prepolymer by reacting the prepolymer with a diamino compound.

To disperse the polyurethane in an aqueous medium emulsifiers can be added to the aqueous solution and/or hydrophilic centers (“internal emulsifiers”) can be included in the polyurethane chain. The hydrophilic centers can be ionic groups such as anionic groups (e.g., carboxylate and sulphonate groups) or cationic groups (e.g., quaternary ammonium groups) or can be non-ionic (e.g., polyethylene glycol (PEG) groups).

Many prepolymers are too viscous to be dispersed in water. Accordingly, many commercial processes for preparing the polyurethane dispersion employ organic solvents to reduce the viscosity of the prepolymer so that it can be more readily dispersed in water. For example, the —NCO terminated prepolymer can be dissolved in an organic solvent (e.g., acetone), the —NCO terminated prepolymer chain extended in the organic solvent, the organic solvent-poyurethane mixture combined with water, and the organic solvent removed. Forming the polyurethane in an organic solvent provides a homogenous, but not to viscous, organic solution that can be dispersed in water. U.S. Pat. No. 3,479,310 to Dieterich et al. discloses a process of forming an aqueous polyurethane dispersion by dissolving a polyurethane prepolymer in an organic solvent, such as acetone; chain extending the polyurethane prepolymer in the organic solvent; combining the organic solvent-poyurethane mixture with water; and then removing the organic solvent to provide the aqueous polyurethane dispersion.

The use of organic solvents in a process for manufacturing an aqueous polyurethane dispersion, however, is undesirable. The use of organic solvents is undesirable since the organic solvent has to be distilled off and recovered, which can be an expensive process, and because organic solvents can be unsafe since they can have adverse health and/or environmental effects and can be dangerous to handle (for example, flammable).

Similarly, N-methylpyrrolidone can be used to reduce the viscosity of the prepolymer. For example, U.S. Pat. No. 6,017,997 to Snow et al. discloses using NMP as a cosolvent to reduce the viscosity of the prepolymer.

Accordingly, there have been developed processes for preparing aqueous polyurethane dispersions that avoid the use of organic solvents. For example, U.S. Pat. No. 3,756,992 to Dieterich et al. discloses a process for preparing solvent free polyurethane dispersions known as the “melt dispersion process.” In this process, an oligourethane modified with ionic groups and containing acylated amino end-groups is reacted with formaldehyde to convert it into an oligourethane that contains methylol end-groups attached to the acylated amino groups. This oligourethane containing methylol end-groups is then chain lengthened by a heat treatment that causes condensation of the reactive methylol end-groups. This chain lengthening reaction can be carried out in the presence of water so that an aqueous dispersion of polyurethane is obtained directly. The reaction to form an oligourethane containing methylol end-groups attached to acylated amino groups and the chain lengthening reaction by condensing the methylol groups attached to the acylamino end-groups is more complicated than the typical, well known, chain lengthening reaction wherein prepolymers containing isocyanate groups are reacted with conventional chain lengthening agents, such as water or diamines. The process, requires an additional step compared to a process that uses a typical chain elongation reaction and also employs the hazardous chemical formaldehyde.

U.S. Pat. No. 6,576,702 to Anderle et al. discloses an aqueous polyurethane dispersion prepared using a plasticizer as a prepolymer diluent in the substantial absence of other organic diluents or solvents.

It is particularly difficult, however, to prepare aqueous dispersions of prepolymers in the absence of an organic co-solvent when the polyol component of the prepolymer is a crystalline polyol with a high melting point or when the polyol component of the prepolymer is an amorphous polyol having a high viscosity since these form prepolymers having high viscosity. For example, prepolymers made from polyester polyols based on phthalic acids have not found widespread commercial utilization in preparing polyurethane dispersions because of their high viscosity. Accordingly, the polyols that can be used to prepare prepolymers for use in organic co-solvent free processes for preparing polyurethane dispersion are limited since many polyols provide a prepolymer that is simply too viscous to be dispersed in aqueous media without the use of an organic co-solvent.

U.S. Pat. No. 4,269,748 to Nachtkamp et al. discloses a process for preparing aqueous solutions or dispersions of polyurethanes wherein prepolymers, which have at least two free isocyanate groups and contain chemically-fixed hydrophilic groups and/or external emulsifiers which are not chemically fixed, are reacted with chain lengthening agents in the aqueous phase. The isocyanate prepolymer which is hydrophilically modified and/or contains an external emulsifier is mixed with chain lengthening agents selected from the group consisting of azines and hydrazones in the absence of water and the mixture obtained is then mixed with water.

U.S. Pat. No. 6,433,073 to Kantner et al. discloses a polyurethane-urea dispersion in an alcohol-water system.

U.S. Pat. Nos. 5,608,000 and 5,703,158 to Duan et al. disclose aqueous dispersion adhesives of anionic polyurethanes that allegedly have high heat resistance and low activation temperature, even when employed without addition of a crosslinker. The polyurethane is the reaction product of an isocyanate terminated polyurethane prepolymer and a chain extender. The polyurethane prepolymer is the reaction product of a polyol component and a diisocyanate component, wherein the polyol component includes a sulfonated polyester polyol; a hydroxy carboxylic acid of the formula (HO)ₓR(COOH)_{y} wherein (R) represents a straight or branched, hydrocarbon radical containing 1 to 12 carbon atoms, and x and y represent values from 1 to 3; and a low molecular weight aliphatic diol having a molecular weight of from 60 to 400.

U.S. Pat. No. 4,108,814 to Reiff et al. discloses a process for the production of water dispersible polyurethanes by reacting polyisocyanates with sulphonate group containing diols. According to the method, a prepolymer is formed with the sulphonate bearing diol, the polyisocyanate, and optionally other reactive hydrogen bearing compounds. The prepolymer is then chain extended with water and water soluble polyamines. This chain extending step can take place in water and the polyamines may carry sulphonate groups.

U.S. Pat. No. 4,292,226 to Wenzel et al. discloses a process for the production of aqueous dispersions or solutions of polyurethane-polyureas by reacting prepolymers containing chemically incorporated hydrophilic groups and/or external chemically non-bound emulsifiers and at least two free isocyanate groups with chain extenders in the aqueous phase, wherein (a) isocyanate-group-containing prepolymer modified by the incorporation of hydrophilic groups and/or containing external emulsifiers are mixed in liquid form and/or in solution in inert solvents in the absence of water with (b) solid adducts, insoluble in the prepolymers or their solutions, of (ba) amines containing at least two primary and/or secondary amino groups and/or hydrazines containing at least one hydrogen atom on both nitrogen atoms and (bb) inorganic or organic acids to form a suspension and the suspension thus formed is subsequently mixed with water.

Despite the available processes for preparing aqueous polyurethane dispersions, there remains a need in the art for new methods of manufacturing aqueous polyurethane dispersions and, in particular, methods that avoid the use of organic solvents. In particular there is a need for methods of manufacturing aqueous polyurethane dispersions from prepolymers made from high melting point polyols or made from viscous polyols. Similarly, there is a need in the art for methods of manufacturing aqueous polyurethane dispersions from highly viscous prepolymers. The present invention addresses these needs. Specifically, the present invention provides processes for preparing polyurethane dispersions using prepolymers that comprise one or more polyols that are too viscous to form a prepolymer or that form prepolymers that are too viscous to be readily dispersed in water. The methods of the invention can be used in organic co-solvent free processes of preparing an aqueous polyurethane dispersion.

Citation of any reference in this section of the application is not to be construed as an admission that such reference is prior art to the present application.

### SUMMARY OF THE INVENTION

The invention relates to a process for making a polyurethane dispersion comprising:

(i) reacting m-TMXDI with a polyol at a temperature ranging from about 60° C. to 170° C. to provide a prepolymer;

(ii) dispersing the prepolymer in an aqueous medium to provide a prepolymer dispersion; and

(iii) extending the prepolymer by adding a diamine to the prepolymer dispersion to provide a polyurethane dispersion.

In one embodiment, the polyol has a viscosity of at least about 1,000 cPs at a temperature of 90° C.

The invention further relates to a process for making a polyurethane dispersion comprising:

(i) reacting m-TMXDI with a polyol to provide a prepolymer;

(ii) dispersing the prepolymer in an aqueous medium at a temperature of at least 50° C.; and

(iii) extending the prepolymer by adding a diamine to the prepolymer dispersion to provide a polyurethane dispersion.

In one embodiment, the polyol has a viscosity of at least about 1,000 cPs at a temperature of 90° C.

In one embodiment, the prepolymer has a viscosity of at least about 5,000 cPs at 60° C.

The invention further relates to a process for making a polyurethane dispersion comprising:

(i) reacting m-TMXDI with a polyol at a temperature ranging from about 60° C. to 170° C. to provide a prepolymer;

(ii) dispersing the prepolymer in an aqueous medium to provide a prepolymer dispersion; and

(iii) extending the prepolymer by reacting the prepolymer with water or a diamine to provide a polyurethane dispersion.

In one embodiment, the polyol has a viscosity of at least about 1,000 cPs at a temperature of 90° C.

### DETAILED DESCRIPTION OF THE INVENTION

The present invention is directed to methods for making a polyurethane dispersions.

### Definitions

The term “dispersion,” as used herein, means a two phase system wherein one phase contains discrete particles distributed throughout a second phase that is a liquid substance. The particles are the disperse or internal phase and the liquid substance is the continuous or external phase. For example, in a “polyurethane dispersion,” the discrete particles are the polyurethane polymer and the liquid substance is an aqueous medium.

The term “active hydrogen containing compound,” as used herein, means a compound that can react with isocyanate groups as depicted below: 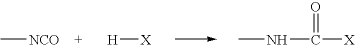
Examples of suitable active hydrogen containing compounds include, but are not limited to alcohols, amines, and thiols, i.e., X is O, N, or S, respectively. Preferably the active hydrogen containing compound is a polyol or polyamine, most preferably a polyol.

The term “polyol,” as used herein, means a compound comprising two or more hydroxyl groups per molecule.

The term “polyamine,” as used herein, means a compound comprising two or more primary or secondary amine groups per molecule.

m-Tetramethylxylylene diisocyanate (m-TMXDI) has the chemical structure:

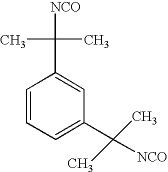

The phrase “aqueous medium,” as used herein, means a liquid medium that is at least about 50 percent by weight of water, preferably at least about 75 percent by weight of water, more preferably at least about 90 percent by weight of water, and most preferably at least about 95 percent by weight of water.

The phrase “substantially free of,” as used herein, means less than about 10 percent, preferably less than about 5 percent, more preferably less than about 1 percent, and most preferably completely free of any given element. For example, the phrase “substantially free of an organic solvent,” means a composition having less than about 10 percent, preferably less than about 5 percent, more preferably less than about 1 percent, and most preferably completely free of an organic solvent.

The phrase “organic solvent free,” as used herein in reference to a composition means that no external organic solvent component has been intentionally added to the composition at any time. It should be understood, and will be readily recognized by one skilled in the art, however, that residual organic solvents may be present inherently in commercially available or synthetically prepared products. Such inherent presence of an organic solvent is not precluded by the term “organic solvent free.”

The term “organic solvent,” as used herein, means an organic compound, generally a liquid, that has the capability of dissolving components that are added to it. As one skilled in the art would readily know, the term “organic solvent,” as used herein, does not include water.

### Processes of Making Polyurethane Dispersions

In one embodiment, the process of making polyurethane dispersions involves (i) reacting m-tetramethylxylylene diisocyanate (m-TMXDI) with an active hydrogen containing compound at a temperature ranging from about 60° C. to 170° C. to provide a prepolymer; (ii) dispersing the prepolymer in an aqueous medium to provide a prepolymer dispersion; and (iii) extending the prepolymer by adding a diamine to the prepolymer dispersion to provide a polyurethane dispersion.

In another embodiment, the process of making polyurethane dispersions involves (i) reacting m-tetramethylxylylene diisocyanate (m-TMXDI) with an active hydrogen containing compound at a temperature ranging from about 60° C. to 170° C. to provide a prepolymer; (ii) dispersing the prepolymer in an aqueous medium to provide a prepolymer dispersion; and (iii) heating the prepolymer dispersion to a temperature sufficient to extend the prepolymer to provide a polyurethane dispersion.

Examples of active hydrogen containing compounds include, but are not limited to, polyols and polyamines. Preferably, the active hydrogen containing compound is a polyol.

Accordingly, the invention further relates to a process that (i) reacting m-tetramethylxylylene diisocyanate (m-TMXDI) with a polyol at a temperature ranging from about 60° C. to 170° C. to provide a prepolymer; (ii) dispersing the prepolymer in an aqueous medium to provide a prepolymer dispersion; and (iii) extending the prepolymer by adding a diamine to the prepolymer dispersion to provide a polyurethane dispersion.

In another embodiment, the process of making polyurethane dispersions involves (i) reacting m-tetramethylxylylene diisocyanate (m-TMXDI) with a polyol at a temperature ranging from about 60° C. to 170° C. to provide a prepolymer; (ii) dispersing the prepolymer in an aqueous medium to provide a prepolymer dispersion; and (iii) heating the prepolymer dispersion to a temperature sufficient to extending the prepolymer to provide a polyurethane dispersion.

Any polyol known to those skilled in the art can be used in the method of the invention. Representative polyols include, but are not limited to, glycols, and polymeric polyols.

Representative glycols include, but are not limited to, alkylene glycols, such as ethylene glycol; 1,2- and 1,3-propylene glycols; 1,2-, 1,3-, 1,4-, and 2,3-butylene glycols; hexane diols; neopentyl glycol; 1,6-hexanediol; 1,8-octanediol; and other glycols such as bisphenol-A, cyclohexane diol, cyclohexane dimethanol (1,4-bis-hydroxymethylcycohexane), 2-methyl-1,3-propanediol, 2,2,4-trimethyl-1,3-pentanediol, triethylene glycol, tetraethylene glycol, polyethylene glycol, dipropylene glycol, polypropylene glycol, dibutylene glycol, polybutylene glycol, caprolactone diol, dimerate diol, hydroxylated bisphenols, polyether glycols, halogenated diols; and mixtures thereof.

Representative polymeric polyols include, but are not limited to, polyester polyols, polyether polyols, polyhydroxy polyester amides, hydroxyl-containing polycaprolactones, hydroxyl-containing acrylic interpolymers, hydroxyl-containing epoxides, polyalkylene ether polyols, polyhydroxy polycarbonates, polyhydroxy polyacetals, polyhydroxy polythioethers, polysiloxane polyols, ethoxylated polysiloxane polyols, polybutadiene polyols, and mixtures thereof. Representative polyols useful in the methods of the invention, include those described in U.S. Pat. Nos. 4,108,814 and 6,576,702, the contents of which are incorporated herein by reference.

Polymeric polyols are preferred. The preferred polymeric polyols include polyester polyols, hydroxy polyethers, hydroxy polythioethers, hydroxy polyacetals, hydroxy polycarbonates, hydroxy polyester amides, and hydroxy polyamides.

Polyester polyols are esterification products prepared by reacting an organic polycarboxylic acids or their anhydrides with a stoichiometric excess of a diol. Examples of suitable polyester polyols for use in the methods of the invention include, but are not limited to, polyglycol adipates, isophthalates, orthophthalates, terephthalates, polycaprolactone polyols, sulfonated polyols, and mixtures thereof.

The diols used in making the polyester polyols include those discussed above. Preferred diols include ethylene glycol, butylene glycol, hexane diol, and neopentyl glycol.

Suitable carboxylic acids used in making the polyester polyols include, but are not limited to, dicarboxylic acids and tricarboxylic acids and anhydrides, e.g., maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids, and mixtures thereof. Preferred polycarboxylic acids used in making the polyester polyols include aliphatic or aromatic dibasic acids.

Hydroxy polyethers suitable for use in the methods of the invention are well known in the art and include, but are not limited to, those obtained by the polymerization of epoxides, such as ethylene oxide, propylene oxide, butylene oxide, tetrahydrofuran, styrene oxide or epichlorohydrin, or mixtures thereof. The epoxides may be polymerized in the presence of a catalyst such as BF₃ or the absence of a catalyst. Hydroxy polyethers can also be formed by an addition of the epoxide, optionally as a mixture of epoxides, to components that contain reactive hydrogen atoms, such as alcohols or amines (e.g, water, ethylene glycol, propylene-1,3- or 1,2-glycol, 4,4′-dihydroxy-diphenylpropane or aniline).

Hydroxy polythioethers suitable for use in the methods of the invention include, but are not limited to, the products obtained by condensing thiodiglycol either on its own and/or with other glycols, dicarboxylic acids, formaldehyde, aminocarboxylic acids, or aminoalcohols. The products obtained are polythio mixed ethers, polythio ether esters, or polythioether ester amides, depending on the reactants.

Hydroxy polyacetals suitable for use in the methods of the invention include, but are not limited to, the reaction product of glycols, such as diethyleneglycol, triethyleneglycol, 4,4′-dioxethoxy-diphenyldimethylmethane and hexane diol with formaldehyde. Polyacetals suitable for use in the the methods of the invention can also be prepared by polymerizing cyclic acetals.

Hydroxy polycarbonates suitable for use in the methods of the invention are known to those skilled in the art and include, but are not limited to, those prepared, by reacting diols, such as propane-1,3-diol, butane-1,4-diol, hexane-1,6-diol, diethylene glycol, triethyleneglycol or tetraethyleneglycol, with diarylcarbonates, such as diphenylcarbonate or phosgene.

Hydroxy polyester amides and hydroxy polyamides suitable for use in the methods of the invention include, but are not limited to, the predominantly linear condensates obtained from the reaction of a saturated or unsaturated polycarboxylic acid or their anyhydride and a polyvalent saturated or unsaturated aminoalcohol, diamine, polyamine, or mixture thereof.

Suitable aminoalcohols, diamines, and polyamines useful in preparing the aforesaid polyester amides and polyamides include, but are not limited to, 1,2-diaminoethane, 1,6-diaminohexane, 2-methyl-1,5-pentanediamine, 2,2,4-trimethyl-1,6-hexanediamine, 1,12-diaminododecane, 2-aminoethanol, 2-[(2-aminoethyl)amino]-ethanol, piperazine, 2,5-dimethylpiperazine, 1-amino-3-aminomethyl-3,5,5-trimethylcyclohexane (isophorone diamine or IPDA), bis-(4-aminocyclohexyl)-methane, bis-(4-amino-3-methyl-cyclohexyl)-methane, 1,4-diaminocyclohexane, 1,2-propylenediamine, hydrazine, urea, amino acid hydrazides, hydrazides of semicarbazidocarboxylic acids, bis-hydrazides and bis-semicarbazides, diethylene triamine, triethylene tetramine, tetraethylene pentamine, pentaethylene hexamine, N,N,N-tris-(2-aminoethyl)amine, N-(2-piperazinoethyl)-ethylene diamine, N,N′-bis-(2-aminoethyl)-piperazine, N,N,N′tris-(2-aminoethyl)ethylene diamine, N-[N-(2-aminoethyl)-2-aminoethyl]-N′-(2-aminoethyl)-piperazine, N-(2-aminoethyl)-N′-(2-piperazinoethyl)-ethylene diamine, N,N-bis-(2-aminoethyl)-N-(2-piperazinoethyl)amine, N,N-bis-(2-piperazinoethyl)-amine, polyethylene imines, iminobispropylamine, guanidine, melamine, N-(2-aminoethyl)-1,3-propane diamine, 3,3′-diaminobenzidine, 2,4,6-triaminopyrimidine, polyoxypropylene amines, tetrapropylenepentamine, tripropylenetetramine, N,N-bis-(6-aminohexyl)amine, N,N′-bis-(3-aminopropyl)ethylene diamine, and 2,4-bis-(4′-aminobenzyl)-aniline, and mixtures thereof. Other suitable diamines and polyamines include Jeffamine® D-2000 and D-4000, which are amine-terminated polypropylene glycols, differing only by molecular weight (commercially available from Huntsman Chemical Company). Polyhydroxyl compounds which already contain urethane or urea groups can also be used.

An examples of a hydroxy polyamide is a linear polyamide formed by reacting adipic acid and 1,6-diamino-hexane. An example of a polyester amides is the reaction product from adipic acid, 1,6-hexanediol and ethylene diamine.

Other representatives active hydrogen containing compounds, which may be used in the methods of the invention, are described in High Polymers, Vol. XVI, “Polyurethanes, Chemistry and Technology” by Saunders-Frisch, Interscience Publishers, New York, London, Volume I, 1962, pages 32-42 and pages 44-54 and Volume II, 1964, pages 5-6 and 198-199, and in Kunststoff-Handbuch, Volume VII, Vieweg-Hochtlen, Carl-Hanser-Verlag, Munich, 1966, e.g. on pages 45 to 71.

In one embodiment, the polyol is a polyester of terephthalic acid and a diol.

In one embodiment, the polyol is a polyester of terephthalic acid and 1,6-hexanediol.

In one embodiment, the polyol is a co-polyester of 1,6-hexanediol, terephthalic acid, and adipic acid.

In one embodiment, the polyol is a co-polyester of 1,6-hexanediol and terephthalic acid, a second diol and terephthalic acid, and adipic acid. For example, the second diol terephthalate can be a terephthalate ester of butane diol, ethylene glycol, or iso-pentyl glycol.

In one embodiment, the polyol is a polyester of isophthalic acid and a diol.

In one embodiment, the polyol is a polyester of isophthalic acid and 1,6-hexanediol.

In one embodiment, the polyol is a co-polyester of 1,6-hexanediol, isophthalic acid, and adipic acid.

In one embodiment, the polyol is a co-polyester of 1,6-hexanediol and isophthic acid, a second diol and isophthic acid, and adipic acid. For example, the second diol isophthalate can be an isophthalate ester of butane diol, ethylene glycol, or iso-pentyl glycol.

In one embodiment, the polyol is a polyester of ortho-phthalic acid and a diol.

In one embodiment, the polyol is a polyester of orthophthalic anhydride and 1,6-hexanediol.

In one embodiment, the polyol is a co-polyester of 1,6-hexanediol, phthalic anhydride, and adipic acid.

In one embodiment, the polyol is a co-polyester of 1,6-hexanediol and orthophthalic acid, a second diol and orthophthalic acid, and adipic acid. For example, the second diol orthophthalate can be an orthophthalate ester of butane diol, ethylene glycol, or iso-pentyl glycol.

In one embodiment, the polyol has a viscosity of at least about 1,000 cPS at 60° C.

In one embodiment, the polyol has a viscosity of at least about 3,000 cPS at 60° C.

In one embodiment, the polyol has a viscosity of at least about 5,000 cPS at 60° C.

In one embodiment, the polyol has a viscosity ranging from about 1,000 cPS to 10,000 cPS at 60° C.

In one embodiment, the polyol has a viscosity ranging from about 3,000 cPS to 10,000 cPS at 60° C.

In one embodiment, the polyol has a viscosity ranging from about 5,000 cPS to 10,000 cPS at 60° C.

In one embodiment, the polyol has a viscosity of at least about 1,000 cPS at 90° C.

In one embodiment, the polyol has a viscosity of at least about 3,000 cPS at 90° C.

In one embodiment, the polyol has a viscosity of at least about 5,000 cPS at 90° C.

In one embodiment, the polyol has a viscosity ranging from about 1,000 cPS to 10,000 cPS at 90° C.

In one embodiment, the polyol has a viscosity ranging from about 3,000 cPS to 10,000 cPS at 90° C.

In one embodiment, the polyol has a viscosity ranging from about 5,000 cPS to 10,000 cPS at 90° C.

In one embodiment, the polyol has a viscosity of at least about 1,000 cPS at 125° C.

In one embodiment, the polyol has a viscosity of at least about 3,000 cPS at 125° C.

In one embodiment, the polyol has a viscosity of at least about 5,000 cPS at 125° C.

In one embodiment, the polyol has a viscosity ranging from about 1,000 cPS to 10,000 cPS at 125° C.

In one embodiment, the polyol has a viscosity ranging from about 3,000 cPS to 10,000 cPS at 125° C.

In one embodiment, the polyol has a viscosity ranging from about 5,000 cPS to 10,000 cPS at 125° C.

In one embodiment, the polyol has a viscosity of at least about 1,000 cPS at 150° C.

In one embodiment, the polyol has a viscosity of at least about 3,000 cPS at 150° C.

In one embodiment, the polyol has a viscosity of at least about 5,000 cPS at 150° C.

In one embodiment, the polyol has a viscosity ranging from about 1,000 cPS to 10,000 cPS at 150° C.

In one embodiment, the polyol has a viscosity ranging from about 3,000 cPS to 10,000 cPS at 150° C.

In one embodiment, the polyol has a viscosity ranging from about 5,000 cPS to 10,000 cPS at 150° C.

Viscosity is determined using a Brookfield RVDV-II+ viscometer (commercially available from Brookfield of Middleboro, Mass.).

In one embodiment, the active hydrogen containing compound is a crystalline solid with a melting point greater than about 60° C. In one embodiment, the active hydrogen containing compound is a crystalline solid with a melting point ranging from about 60° C. to 150° C. In one embodiment, the active hydrogen containing compound is a crystalline solid with a melting point ranging from about 60° C. to 130° C. In one embodiment, the active hydrogen containing compound is a crystalline solid with a melting point ranging from about 60° C. to 120° C. In one embodiment, the active hydrogen containing compound is a polyol.

In one embodiment, the active hydrogen containing compound is a crystalline solid with a melting point greater than about 70° C. In one embodiment, the active hydrogen containing compound is a crystalline solid with a melting point ranging from about 70° C. to 150° C. In one embodiment, the active hydrogen containing compound is a crystalline solid with a melting point ranging from about 70° C. to 130° C. In one embodiment, the active hydrogen containing compound is a crystalline solid with a melting point ranging from about 70° C. to 120° C. In one embodiment, the active hydrogen containing compound is a polyol.

In one embodiment, the active hydrogen containing compound is a crystalline solid with a melting point greater than about 80° C. In one embodiment, the active hydrogen containing compound is a crystalline solid with a melting point ranging from about 80° C. to 150° C. In one embodiment, the active hydrogen containing compound is a crystalline solid with a melting point ranging from about 80° C. to 130° C. In one embodiment, the active hydrogen containing compound is a crystalline solid with a melting point ranging from about 80° C. to 120° C. In one embodiment, the active hydrogen containing compound is a polyol.

In one embodiment, the active hydrogen containing compound is a crystalline solid with a melting point greater than about 90° C. In one embodiment, the active hydrogen containing compound is a crystalline solid with a melting point ranging from about 90° C. to 150° C. In one embodiment, the active hydrogen containing compound is a crystalline solid with a melting point ranging from about 90° C. to 130° C. In one embodiment, the active hydrogen containing compound is a crystalline solid with a melting point ranging from about 90° C. to 120° C. In one embodiment, the active hydrogen containing compound is a polyol.

In one embodiment, the active hydrogen containing compound is a crystalline solid with a melting point greater than about 100° C. In one embodiment, the active hydrogen containing compound is a crystalline solid with a melting point ranging from about 100° C. to 150° C. In one embodiment, the active hydrogen containing compound is a crystalline solid with a melting point ranging from about 100° C. to 130° C. In one embodiment, the active hydrogen containing compound is a crystalline solid with a melting point ranging from about 100° C. to 120° C. In one embodiment, the active hydrogen containing compound is a polyol.

In one embodiment, the active hydrogen containing compound is a crystalline solid with a melting point greater than about 120° C. In one embodiment, the active hydrogen containing compound is a crystalline solid with a melting point ranging from about 120° C. to 150° C. In one embodiment, the active hydrogen containing compound is a crystalline solid with a melting point ranging from about 120° C. to 130° C. In one embodiment, the active hydrogen containing compound is a crystalline solid with a melting point ranging from about 120° C. to 125° C. In one embodiment, the active hydrogen containing compound is a polyol.

The m-TMXDI and active hydrogen containing compound, preferably a polyol, are reacted at a temperature ranging from about 60° C. to 170° C. In one embodiment, the m-TMXDI and active hydrogen containing compound, preferably a polyol, are reacted at a temperature ranging from about 70° C. to 170° C. In one embodiment, the m-TMXDI and active hydrogen containing compound, preferably a polyol, are reacted at a temperature ranging from about 80° C. to 170° C. In one embodiment, the m-TMXDI and active hydrogen containing compound, preferably a polyol, are reacted at a temperature ranging from about 90° C. to 170° C. In one embodiment, the m-TMXDI and active hydrogen containing compound, preferably a polyol, are reacted at a temperature ranging from about 100° C. to 170° C. In one embodiment, the m-TMXDI and active hydrogen containing compound, preferably a polyol, are reacted at a temperature ranging from about 110° C. to 170° C. In one embodiment, the m-TMXDI and active hydrogen containing compound, preferably a polyol, are reacted at a temperature ranging from about 120° C. to 170° C.

When the polyol is a solid, the m-TMXDI and polyol are reacted at a temperature sufficiently high to melt the polyol.

One skilled in the art would readily know the amounts of m-TMXDI and active hydrogen containing compound to be reacted to prepare the prepolymer. Typically, the ratio of NCO groups in the m-TMXDI to active hydrogens in the active hydrogen containing compound is about 1.2/1 to 2/1 in order to provide a prepolymer of reasonable viscosity. When the ratio is greater than 2/1, the diol or amine portions of the prepolymer are essentially endcapped by the m-TMXDI species, to provide a prepolymer of relatively low viscosity. As the ratio of NCO groups in the m-TMXDI to active hydrogens in the active hydrogen containing compound is reduced, the viscosity increases. If the ratio of NCO groups in the m-TMXDI to active hydrogens in the active hydrogen containing compound is increased above about 2/1, the molecular weight will be limited as with the 2/1 ratio, but the excess m-TMXDI will function as a diluent, further reducing viscosity. Although reduced viscosity is desired, raising the ratio above about 2/1 can have negative effects. For example, when the ratio is increased, the hardness, or modulus of the polyurethane, along with the yield point, is increased. This is undesirable for producing a “rubbery” polymer. Also, when excess m-TMXDI (obtained from using a ratio much greater than about 2/1) is introduced into a dispersion and the prepolymer is extended with an amine, high molecular weight polyureas can be formed that are not easily dispersable. This can result in the formation of a gel rather than a dispersion or sedimentation in the polyurethane dispersion, all of which can result in grittiness in a cast film or a weakened film having a poor appearance. For these reasons, the preferred ratio of NCO groups in the m-TMXDI to active hydrogens in the active hydrogen containing compound ranges from about 1.2/1 to about 2.4/1, more preferably about 1.3/1 to 2.2/1, and more preferably about 1.4/1 to 2/1.

In one embodiment, forming the prepolymer comprises reacting m-tetramethylxylylene diisocyanate (m-TMXDI); an active hydrogen containing compound, preferably a polyol; and a water solubilizing monomer at a temperature ranging from about 60° C. to 170° C. to provide a prepolymer that comprises a water solubilizing group.

A water solubilizing monomer is a compound bearing a hydrophilic group or an ionic group (or a group that can be made into a hydrophilic group or ionic group) that facilitates solubility or dispersion in water and that can be incorporated into the polymer chain of the prepolymer. Representative groups that that facilitate solubility in water include, but are not limited to, hydroxyl groups, carboxyl groups, sulphonate groups, amino groups, and quaternary ammonium groups.

One skilled in the art would readily know water solubilizing monomers that are useful for preparing prepolymers. Representative water solubilizing monomers useful in the methods of the invention include, but are not limited to, hydroxy-carboxylic acids having the general formula (HO)ₓQ(COOH)_{y}, wherein Q is a straight or branched hydrocarbon radical containing 1 to 12 carbon atoms, x and y ranges from 1 to 3 such as those described in U.S. Pat. No. 6,576,702, the contents of which are incorporated herein by reference. Examples of such hydroxy-carboxylic acids include citric acid, dimethylolpropanoic acid (DMPA), dimethylol butanoic acid (DMBA), glycolic acid, lactic acid, malic acid, dihydroxymalic acid, and dihydroxytartaric acid. Dihydroxy-carboxylic acids are more preferred with dimethylolproanoic acid (DMPA) being most preferred. Other suitable water solubilizing monomer include thioglycolic acid, 2,6-dihydroxybenzoic acid, sulfoisophthalic acid, and polyethylene glycol.

Typically, the water solubilizing monomer is present in an amount ranging from about 1 to 10 percent by weight of the prepolymer. In one embodiment, the water solubilizing monomer is present in an amount ranging from about 2 to 8 percent by weight of the prepolymer. In one embodiment, the water solubilizing monomer is present in an amount ranging from about 3 to 6 percent by weight of the prepolymer.

In one embodiment, the hydrophilic monomer is dimethylolpropionic acid (DMPA).

Using m-TMXDI as the isocyanate advantageously allows the reaction to form the prepolymer to be conducted at temperatures higher than can be used for other isocyanates. Commercial process for forming prepolymers are conducted at temperatures of less than 100° C., typically between about 80° C. and 90° C., to avoid side reactions. For example, at temperatures above 100° C., and often above 90° C. or even 80° C., a common side reaction that occurs is a reaction between the isocyanate and amide functional group of urethane or urea linkages in the prepolymer, which leads to the undesirable formation of alophanate or biuret compounds. This side reaction results in unfavorable prepolymer branching that leads to an unacceptable increase in prepolymer viscosity. This side reaction leading to alophanate or biuret compounds and unfavorable prepolymer branching, however, is greatly reduced when m-TMXDI is used as the isocyanate. Indeed, m-TMXDI can be used to prepare prepolymers at temperatures up to about 170° C. with minimal, if any, side reactions leading to alophanate or biuret compounds and unfavorable prepolymer branching.

Similarly, when the prepolymer further comprises a carboxyl group, for example, if the prepolymer contains a water solubilizing group that includes a carboxyl group (such as DPMA), there can be a side reaction between the carboxyl group and the isocyanate at temperatures above 100° C., and often above 90° C. or even 80° C. This side reaction also leads to undesirable prepolymer branching. Advantageously, this side reaction is also minimal when m-TMXDI is used as the isocyanate. Indeed, m-TMXDI can be used to prepare prepolymers at temperatures up to about 170° C. with minimal, if any, side reactions between isocyanates and carboxyl groups of the prepolymer.

Accordingly, since, by using m-TMXDI, it is possible to prepare prepolymers at higher temperatures, without side reactions, it is possible to prepare prepolymers from polyols that would otherwise be a solid or too viscous at lower temperatures to be used in a reaction to form a prepolymer.

Although the m-TMXDI can be reacted to form the prepolymer in an organic solvent and the organic solvent then removed to provide the prepolymer, it is preferred that the m-TMXDI and polyol are reacted in the absence of a solvent. For example, the prepolymer can be prepared by simply combining the m-TMXDI, the polyol, and the optionally hydrophilic monomer to provide a mixture and heating the mixture to a temperature ranging from about 60° C. to 170° C.

Formation of the prepolymer can take place with or without the use of a catalyst. Suitable catalysts useful for preparing the prepolymer include, but are not limited to, stannous octoate, dibutyl tin dilaurate, and tertiary amine compounds such as triethylamine and bis-(dimethylaminoethyl) ether, morpholine compounds such as β β′-dimorpholinodiethyl ether, bismuth carboxylates, zinc bismuth carboxylates, iron (III) chloride, potassium octoate, potassium acetate, DABCO® (bicycloamine) (commercially available from from Air Products), and FASCAT® 2003 (commercially available from Arkema of France). The amount of catalyst used is typically from about 5 to about 200 parts per million of the total weight of prepolymer reactants.

The prepolymer can be dispersed in an aqueous medium using any method known to those skilled in the art. Typically, the prepolymer is simply added to the aqueous medium with stirring, preferably rapid stirring. Sometimes, high speed/high shear stirring is used to obtain a dispersion of good quality. Typically, the prepolymer and the aqueous medium are combined to provide a polyurethane dispersion wherein the ratio of prepolymer to aqueous medium ranges from about 1/4 to 1/3, preferably 1/2 to 1/1 by weight.

The prepolymer can be dispersed in the aqueous medium at any temperature. Typically, however, the temperature is below the boiling point of the aqueous medium. By using a closed reactor capable of withstanding elevated pressure, however, it is possible to disperse the prepolymer in the aqueus medium at a temperature higher than the boiling point of the aqueous medium. Generally, in commercial processes for preparing polyurethane dispersions the prepolymer is dispersed in the aqueous medium at a temperature of less than about 50° C. and often less than about 25° C. The relatively low temperature is required since the isocyanate groups of the prepolymer undergo a relatively rapid reaction with water that leads to polymerization that renders the prepolymer not dispersible in the water. Furthermore, the rapid reaction of the isocyanate groups of the prepolymer with water, at higher temperatures, leads to the formation of carbon dioxide that results in foaming, which renders the process difficult to perform. By lowering the temperature at which the dispersion is formed reduces this side reaction. Accordingly, in one embodiment, the prepolymer is dispersed in the aqueous medium at a temperature less than about 50° C. In one embodiment, the prepolymer is dispersed in the aqueous medium at a temperature ranging from about 20° C. to 50° C. In one embodiment, the prepolymer is dispersed in the aqueous medium at a temperature less than about 25° C.

When m-TMXDI is used as the isocyanate to prepare the prepolymer, however, this side reaction of the isocyanate groups of the prepolymer with water leading to carbon dioxide formation is much slower. Accordingly, by using m-TMXDI as the isocyanate used to prepare the prepolymer allows the prepolymer to be dispersed in the aqueous medium at a temperature higher than is possible with prepolymers prepared from other isocyanates. Therefore, by dispersing the prepolymer at a higher temperature, it is possible to disperse prepolymers that at lower temperatures would be too viscous to be dispersed.

Accordingly, in another embodiment, the prepolymer is dispersed in the aqueous medium at a temperature of greater than 50° C. In one embodiment, the prepolymer is dispersed in the aqueous medium at a temperature of greater than 60° C. In one embodiment, the prepolymer is dispersed in the aqueous medium at a temperature of greater than 70° C. In one embodiment, the prepolymer is dispersed in the aqueous medium at a temperature of greater than 80° C. In one embodiment, the prepolymer is dispersed in the aqueous medium at a temperature of greater than 90° C. In one embodiment, the prepolymer is dispersed in the aqueous medium at a temperature of greater than 95° C.

In one embodiment, the invention relates to process for making a polyurethane dispersion comprising (i) reacting m-TMXDI with a polyol to provide a prepolymer; (ii) dispersing the prepolymer in an aqueous medium at a temperature of at least 50° C.; and (iii) extending the prepolymer by adding a diamine to the prepolymer dispersion to provide a polyurethane dispersion.

In one embodiment, the invention relates to process for making a polyurethane dispersion comprising (i) reacting m-TMXDI with a polyol to provide a prepolymer; (ii) dispersing the prepolymer in an aqueous medium at a temperature of at least 60° C.; and (iii) extending the prepolymer by adding a diamine to the prepolymer dispersion to provide a polyurethane dispersion.

In one embodiment, the invention relates to process for making a polyurethane dispersion comprising (i) reacting m-TMXDI with a polyol to provide a prepolymer; (ii) dispersing the prepolymer in an aqueous medium at a temperature of at least 70° C.; and (iii) extending the prepolymer by adding a diamine to the prepolymer dispersion to provide a polyurethane dispersion.

In one embodiment, the invention relates to process for making a polyurethane dispersion comprising (i) reacting m-TMXDI with a polyol to provide a prepolymer; (ii) dispersing the prepolymer in an aqueous medium at a temperature of at least 80° C.; and (iii) extending the prepolymer by adding a diamine to the prepolymer dispersion to provide a polyurethane dispersion.

In one embodiment, the invention relates to process for making a polyurethane dispersion comprising (i) reacting m-TMXDI with a polyol to provide a prepolymer; (ii) dispersing the prepolymer in an aqueous medium at a temperature of at least 90° C.; and (iii) extending the prepolymer by adding a diamine to the prepolymer dispersion to provide a polyurethane dispersion.

In one embodiment, the invention relates to process for making a polyurethane dispersion comprising (i) reacting m-TMXDI with a polyol to provide a prepolymer; (ii) dispersing the prepolymer in an aqueous medium at a temperature of at least 95° C.; and (iii) extending the prepolymer by adding a diamine to the prepolymer dispersion to provide a polyurethane dispersion.

In one embodiment, the prepolymer has a viscosity of at least about 5,000 cPs at 60° C.

In one embodiment, the prepolymer has a viscosity of at least about 10,000 cPs at 60° C.

In one embodiment, the prepolymer has a viscosity of at least about 15,000 cPs at 60° C.

In one embodiment, the prepolymer has a viscosity of at least about 20,000 cPs at 60° C.

In one embodiment, the prepolymer has a viscosity that ranges from about 5,000 cPs to 100,000 cPs at 60° C.

In one embodiment, the prepolymer has a viscosity that ranges from about 10,000 cPs to 100,000 cPs at 60° C.

In one embodiment, the prepolymer has a viscosity that ranges from about 15,000 cPs to 100,000 cPs at 60° C.

In one embodiment, the prepolymer has a viscosity that ranges from about 20,000 cPs to 100,000 cPs at 60° C.

In one embodiment, the prepolymer has a viscosity of at least about 5,000 cPs at 80° C.

In one embodiment, the prepolymer has a viscosity of at least about 10,000 cPs at 80° C.

In one embodiment, the prepolymer has a viscosity of at least about 15,000 cPs at 80° C.

In one embodiment, the prepolymer has a viscosity of at least about 20,000 cPs at 80° C.

In one embodiment, the prepolymer has a viscosity that ranges from about 5,000 cPs to 100,000 cPs at 80° C.

In one embodiment, the prepolymer has a viscosity that ranges from about 10,000 cPs to 100,000 cPs 80° C.

In one embodiment, the prepolymer has a viscosity that ranges from about 15,000 cPs to 100,000 cPs at 80° C.

In one embodiment, the prepolymer has a viscosity that ranges from about 20,000 cPs to 100,000 cPs at 80° C.

In one embodiment, the prepolymer has a viscosity of at least about 5,000 cPs at 100° C.

In one embodiment, the prepolymer has a viscosity of at least about 10,000 cPs at 100° C.

In one embodiment, the prepolymer has a viscosity of at least about 15,000 cPs at 100° C.

In one embodiment, the prepolymer has a viscosity of at least about 20,000 cPs at 100° C.

In one embodiment, the prepolymer has a viscosity that ranges from about 5,000 cPs to 100,000 cPs at 100° C.

In one embodiment, the prepolymer has a viscosity that ranges from about 10,000 cPs to 100,000 cPs at 100° C.

In one embodiment, the prepolymer has a viscosity that ranges from about 15,000 cPs to 100,000 cPs at 100° C.

In one embodiment, the prepolymer has a viscosity that ranges from about 20,000 cPs to 100,000 cPs at 100° C.

In one embodiment, the prepolymer has a viscosity of at least about 5,000 cPs at 125° C.

In one embodiment, the prepolymer has a viscosity of at least about 10,000 cPs at 125° C.

In one embodiment, the prepolymer has a viscosity of at least about 15,000 cPs at 125° C.

In one embodiment, the prepolymer has a viscosity of at least about 20,000 cPs at 125° C.

In one embodiment, the prepolymer has a viscosity that ranges from about 5,000 cPs to 100,000 cPs at 125° C.

In one embodiment, the prepolymer has a viscosity that ranges from about 10,000 cPs to 100,000 cPs at 125° C.

In one embodiment, the prepolymer has a viscosity that ranges from about 15,000 cPs to 100,000 cPs at 125° C.

In one embodiment, the prepolymer has a viscosity that ranges from about 20,000 cPs to 100,000 cPs at 125° C.

In one embodiment, the prepolymer is dispersed in the aqueous medium to provide a dispersion that is substantially free of any organic solvent.

In one embodiment, the prepolymer is dispersed in the aqueous medium to provide a dispersion that is organic solvent free.

In one embodiment, the prepolymer is dispersed in the aqueous medium to provide a dispersion that is substantially free of emulsifiers.

In one embodiment, the prepolymer is dispersed in the aqueous medium to provide a dispersion that includes an emulsifier. An emulsifier facilitates dispersion of the prepolymer in the aqueous medium. The emulsifier can be added to the aqueous medium before or after adding the prepolymer to the aqueous medium.

Any emulsifier known to those skilled in the art can be used in the methods of the invention. Suitable plasticizers useful as emulsifiers include, but are not limited to, those described in U.S. Pat. No. 6,576,702, the contents of which are expressly incorporated herein by reference. Typically, if used, the emulsifier is present in an amount of less than about 20 percent, more preferably less than about 10 percent, and most preferably less than about 5 percent by weight of the prepolymer.

In one embodiment, the aqueous medium comprises water in an amount ranging from about 90 to 99 percent by weight and a neutralizing agent, such as a tertiary amine or metal hydroxide, in an amount ranging from about 10 to 1 percent by weight of the neutralizing agent. In one embodiment metal hydroxide is an alkali or alkaline earth hydroxide. In one embodiment, the aqueous medium comprises about 90 percent by weight of water and about 10 percent by weight of a metal hydroxide. In one embodiment, the aqueous medium comprises about 95 percent by weight of water and about 5 percent by weight of a metal hydroxide. In one embodiment, the aqueous medium comprises about 99 percent by weight of water and about 1 percent by weight of a metal hydroxide. In one embodiment, the neutralizing agent is a tertiary amine. In one embodiment, the aqueous medium comprises about 90 percent by weight of water and about 10 percent by weight of a tertiary amine. In one embodiment, the aqueous medium comprises about 95 percent by weight of water and about 5 percent by weight of a tertiary amine. In one embodiment, the aqueous medium comprises about 99 percent by weight of water and about 1 percent by weight of a tertiary amine. An aqueous media comprising water and a tertiary amine are typically used when the prepolymer contains a water solubilizing group that includes a carboxyl group (such as DPMA). Sutiable tertiary amines include, but are not limited to, triethylamine and 2-dimetylamino-2-methyl-1-propanol (DMAMP).

After the prepolymer is dispersed in the aqueous medium, the prepolymer is reacted with a polyamine or water to provide the polyurethane dispersion. Reacting the prepolymer with water or a polyamine lengthens the prepolymer to form a polyurethane dispersed in water. In one embodiment, the polyamine is a diamine.

In one embodiment, the prepolymer is simply reacted with water (i.e., without adding a diamine) to extend the prepolymer and provide the polyurethane dispersion. Without wishing to be bound by theory, it is believed that reacting the prepolymer with water causes some of the terminal isocyanate groups of the prepolymer molecule to form terminal amino groups that can then react with other terminal isocyanate groups in other prepolymer molecules to lengthens the prepolymer and form the polyurethane dispersion. In one embodiment, the prepolymer is reacted with water at a temperature of greater than 50° C. In one embodiment, the prepolymer is reacted with water at a temperature of greater than 60° C. In one embodiment, the prepolymer is reacted with water at a temperature of greater than 70° C. In one embodiment, the prepolymer is reacted with water at a temperature of greater than 80° C. In one embodiment, the prepolymer is reacted with water at a temperature of greater than 90° C. In one embodiment, the prepolymer is reacted with water at a temperature of greater than 95° C. Without wishing to be bound by theory, it is believed that m-TMXDI reacts more slowly with water than other diisocyanates. Accordingly, a viscous prepolymer prepared using m-TMXDI can be heated to an elevated temperatures to permit reaction with water and chain elongation without the reaction with water occurring so quickly as to cause foaming.

In one embodiment, the prepolymer is reacted with a polyamine to form the polyurethane dispersion. In one embodiment, the prepolymer is reacted with a diamine to form the polyurethane dispersion.

Any polyamine known to those skilled in the art can be used to extend the prepolymer and form the polyurethane dispersion. Any inorganic or organic polyamine having an average of about 2 or more primary and/or secondary amine groups, or combinations thereof, is suitable for use in the methods of the invention. Representative organic amines for use as a chain extender include, but are not limited to, diethylene triamine (DETA), ethylene diamine (EDA), meta-xylylenediamine (MXDA), aminoethyl ethanolamine (AEEA), 2-methyl pentane diamine, propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, and mixtures thereof. Representative inorganic amines include hydrazine, substituted hydrazines, and hydrazine reaction products.

The amount of polyamine typically ranges from about 0.25 to 1.2 equivalents, preferably about 0.5 to about 0.95 equivalents, per equivalent of isocyanate groups in the prepolymer.

Typically, the prepolymer is reacted with the polyamine at a temperature ranging from about 20° C. to 90° C., preferably about 20° C. to 70° C., and more preferably about 20° C. to 50° C. The reaction is allowed to proceed until the reaction extending the prepolymer is complete. Generally, the reaction is complete in a few minutes.

Other additives, well known to those skilled in the art, can also be included in the polyurethane dispersion. Representative additives include, but are not limited to, surfactants, stabilizers, defoamers, antimicrobial agents, and antioxidants.

The methods of the invention can be used to provide polyurethane dispersions that provide polymers having a wide variety of properties and applications. For example, by varying the polyol, varying the amount of urethane and urea linkages in the polyurethane polymer, one can obtain polymers and products suitable for a variety of applications.

Additives can optionally be added as appropriate during the processing of the dispersions into finished products, as is well known to those skilled in the art. Additives may be used as appropriate in order to make articles (for example, flexible articles, such as gloves) or to impregnate, saturate, spray or coat papers, non-woven materials, textiles, wood, metals, polymeric articles, and a variety of other substrates. For example, the dispersions can be applied to papers, non-wovens and fibrous materials such as textiles (including application to upholstery, carpets, tents, awnings, clothing, and the like); formed into films, sheets, composites, and other articles; used in inks and printing binders; used as adhesives; and used in personal care products such as skin care, hair care, and nail care products; and the like. Representative additives include, but are not limited to, activators, curing agents, stabilizers, colorants, pigments, neutralizing agents, coagulating agents such as calcium nitrate, coalescing agents such as di(propylene glycol) methyl ether (DPM), waxes, slip and release agents, antimicrobial agents, surfactants such as silicone surfactants, metals, antioxidants, UV stabilizers, antiozonants, and the like.

The following examples are set forth to assist in understanding the invention and should not be construed as specifically limiting the invention described and claimed herein. Variations of the invention, including the substitution of all equivalents now known or later developed, which would be within the purview of those skilled in the art, and changes in formulation or changes in experimental design, are to be considered to fall within the scope of the invention incorporated herein.

### EXAMPLES

### Example 1

### Preparation of a Polyurethane Dispersion

215.5 grams of hexamethyleneadipate/terephthalate glycol (Piothane 3500 HAT, molecular weight 35000, commercially available from Panolam Industries, Inc.) was carefully melted by heating to 100° C. in 500 mL glass reaction kettle, equipped with a stirrer and condenser. 15.0 Grams of Dimethylolpropionic acid (DMPA) was then added to the kettle and stirred with the molten polyester. 69.5 grams of m-TMXDI was then added slowly and temperature maintained at about 125° C. for 4 hours. Cooling was applied as needed to keep the temperature from exceeding 150° C. After four hours of reaction the free-NCO content of the prepolymer was 2.53%, as determined by standard titration method (ASTM D2572-97). The prepolymer at 125° C. was then dispersed in 506 g of water pre-heated to 80° C. and admixed with 13.6 g of 2-dimethylamino-2-methyl-1-propanol (DMAMP-80, 80% in water, commercially available from Angus Chemical Co.) with moderate stirring. Cooling was applied to maintain the temperature of the dispersion below 90° C. 15 Minutes after dispersing the prepolymer (281 grams), the dispersion was cooled to 35° C. and the prepolymer was chain-extended with hydrazine by adding of 35% aqueous hydrazine solution. The reaction was considered complete when a Fourier transform infra red (FTIR) spectrum showed no signal corresponding to an NCO group (after adding 7.7 grams of 35% aqueous hydrazine solution). The resulting polyurethane dispersion had a solids content of 34.9% and a viscosity of 60 cPs (Brookfield LV viscometer, spindle #2, 60 rpm). The dispersion forms a film at room temperature without addition of coalescing solvents and provides a surface hardness of 43% relative to glass as measured by the Sward hardness method (ASTM D2134-93). The coating provided a bond strength of 20 pli when heat-activated at 100° C., using cotton fabric as a substrate (ASTM D1876-01). The polyurethane dispersion is suitable for use as a coating and has good surface hardness. The polyurethane dispersion is also suitable for heat-sealing different substrates.

### Example 2

### Preparation of a Polyurethane Dispersion

A polyurethane dispersion was prepared in the same way as in Example 1, except that the polyol used to prepare the prepolymer was hexamethyleneadipate/iso-phthalate having a molecular weight of 3500 (Lexorez 3130-35, commercially vavailable from Inolex). The resulting polyurethane dispersion had solids contents of 35%. A film, prepared from the polyurethane dispersion by an ionic deposition process had an ultimate tensile strength of 5000 psi, an elongation at break of 650%, and a stress at 100% elongation of 1200 psi. The polyurethane dispersion is useful for forming elastic rubber-like free films.

### Example 3

### Preparation of a Polyurethane Dispersion

A polyurethane dispersion was prepared in the same way as in Example 1, except the polyol used to prepare the prepolymer was a 50/50 mixture of two polyesters, hexamethyleneadipate/iso-phthalate and hexamethyleneadipate/terephthalate, both having a molecular weight of 3500. The resulting polyurethane dispersion formed a film at room temperature that was highly flexible and exhibited specific tactile property usually designated as “soft feel” without any residual tackiness.

The present invention is not to be limited in scope by the specific embodiments disclosed in the examples which are illustrations of a few aspects of the invention and any embodiments that are functionally equivalent are within the scope of this invention. Indeed, various modifications of the invention in addition to those shown and described herein will become apparent to those skilled in the art and are intended to fall within the scope of the appended claims.

A number of references have been cited, the entire disclosure of which are incorporated herein by reference.

1. A process for making a polyurethane dispersion comprising:
(i) reacting m-TMXDI with a polyol at a temperature ranging from about 60° C. to 170° C. to provide a prepolymer;
(ii) dispersing the prepolymer in an aqueous medium to provide a prepolymer dispersion; and
(iii) extending the prepolymer by adding a diamine to the prepolymer dispersion to provide a polyurethane dispersion.

2. The method of claim 1, wherein the polyol has a viscosity of at least 3,000 cPs at a temperature of 90° C.

3. The method of claim 1, wherein the polyol is a crystalline solid.

4. The method of claim 1, wherein m-TMXDI and the polyol are reacted in the absence of a solvent.

5. The method of claim 1, wherein the prepolymer is dispersed in an aqueous medium at a temperature of at least about 50° C.

6. The method of claim 1, wherein the aqueous medium is water substantially free of an organic solvent.

7. The method of claim 1, wherein the aqueous medium is organic solvent free.

8. The method of claim 1, wherein forming the prepolymer further comprises reacting the m-TMXDI and polyol with a water solubilizing monomer.

9. A process for making a polyurethane dispersion comprising:
(i) reacting m-TMXDI with a polyol to provide a prepolymer;
(ii) dispersing the prepolymer in an aqueous medium at a temperature of at least about 50° C.; and
(iii) extending the prepolymer by adding a diamine to the prepolymer dispersion to provide a polyurethane dispersion.

10. The method of claim 9, wherein m-TMXDI and the polyol are reacted in the absence of a solvent.

11. The method of claim 9, wherein the aqueous medium is water substantially free of an organic solvent.

12. The method of claim 9, wherein the aqueous medium is organic solvent free.

13. The method of claim 9, wherein the prepolymer has a viscosity of at least about 5,000 cPs at 60° C.

14. The method of claim 9, wherein forming the prepolymer further comprises reacting the m-TMXDI and polyol with a water solubilizing monomer.

15. A process for making a polyurethane dispersion comprising:
(i) reacting m-TMXDI with a polyol at a temperature ranging from about 60° C. to 170° C. to provide a prepolymer;
(ii) dispersing the prepolymer in an aqueous medium to provide a prepolymer dispersion; and
(iii) extending the prepolymer by reacting the prepolymer with water or a diamine to provide a polyurethane dispersion.

16. The method of claim 15, wherein the polyol has a viscosity of at least 3,000 cPs at a temperature of 90° C.

17. The method of claim 15, wherein the polyol is a crystalline solid.

18. The method of claim 15, wherein m-TMXDI and the polyol are reacted in the absence of a solvent.

19. The method of claim 15, wherein the prepolymer is dispersed in the aqueous medium at a temperature of at least about 50° C.

20. The method of claim 15, wherein the aqueous medium is water substantially free of an organic solvent.

21. The method of claim 15, wherein the aqueous medium is organic solvent free.

22. The method of claim 15, wherein forming the prepolymer further comprises reacting the m-TMXDI and polyol with a water solubilizing monomer.
